(19) United States
(12) Patent Application Publication
(10) Pub. No.: US 2019/0227522 A1
(43) Pub. Date: Jul. 25, 2019

(54) MEASUREMENT RESULT ANALYSIS DEVICE, MEASUREMENT RESULT ANALYSIS METHOD, AND COMPUTER READABLE MEDIUM

(71) Applicant: FANUC CORPORATION, Yamanashi (JP)

(72) Inventor: Ryuta HITOMI, Yamanashi (JP)

(21) Appl. No.: 16/251,261

(22) Filed: Jan. 18, 2019

(30) Foreign Application Priority Data
Jan. 22, 2018 (JP) 2018-008394

(51) Int. Cl. G05B 19/408; G05B 19/406

(52) U.S. Cl. CPC G05B 19/408; G05B 2219/32175; G05B 19/406

(57) ABSTRACT

A measurement result analysis device includes: a measurement result classification unit that classifies measurement result information on the basis of the measurement result information in which measurement results of a machine tool and measurement attributes of the measurement results are correlated; a measurement result extraction unit that acquires related information including classifications of the measurement result information on the basis of a content of an analysis result for which it is instructed to output with respect to the measurement result information; and an analysis result display unit that outputs an analysis result for the measurement result information on the basis of the related information acquired by the measurement result extraction unit.

This application is based on and claims the benefit of priority from Japanese Patent Application No. 2018-008394, filed on 22 Jan. 2018, the content of which is incorporated herein by reference.

### FIELD OF THE INVENTION

The present invention relates to a measurement result analysis device, a measurement result analysis method, and a computer readable medium.

### RELATED ART

Conventionally, a technology of storing measurement results of tools or works executed in a machine tool is known. For example, Patent Document 1 discloses a technology of storing measurement results of a machine tool together with tool information and displaying the measurement result according to an instruction of a user.

Patent Document 1: Japanese Unexamined Patent Application, Publication No. H10-143219

### SUMMARY OF THE INVENTION

However, in the conventional technology, the measurement results of a machine tool are stored in an execution order of measurement. In this case, it is not easy to perform analysis of comparing measurement results under the same conditions except a tool to read the tendency of wearing of tools in order to compare performance of tools. That is, in the conventional technology, it is difficult to analyze measurement results of a machine tool appropriately.

An object of the present invention is to analyze measurement, results of a machine tool more appropriately.

(1) A measurement result analysis device (for example, a measurement result analysis device 1 to be described later) according to an aspect of the present invention includes: a measurement result classification unit (for example, a measurement result classification unit 11d to be described later) that classifies measurement result information on the basis of the measurement result information in which measurement results of a machine tool and measurement attributes of the measurement results are correlated; a related information acquisition unit (for example, a measurement result extraction unit 11f to be described later) that acquires related information including classifications of the measurement result information on the basis of a content of an analysis result for which it is instructed to output with respect to the measurement result information; and an analysis result output unit (for example, an analysis result display unit 11g to be described later) that outputs an analysis result for the measurement result information on the basis of the related information acquired by the related information acquisition unit (11f).

(2) in the measurement result analysis device according to (1), the measurement result classification unit may determine whether the measurement result information corresponds to an already-existing classification of the measurement result information, set the corresponding classification of the measurement result information when the measurement result information corresponds to the already-existing classification of the measurement result information, and generate a new classification of the measurement result information and set the generated new classification of the measurement result information when the measurement result information does not corresponds to the already-existing classification of the measurement result information.

(3) The measurement result analysis device according to (1) or (2) may further include an analysis target classification unit (for example, an analysis target classification unit 11e to be described later) that specifies a classification of the other comparison target measurement result with respect to the measurement result information classified by the measurement result classification unit, and the related information acquisition unit may acquire related information including classifications of the measurement result information and a classification of the other comparison target measurement results on the basis of a content of an analysis result for which it is instructed to output with respect to the measurement result information.

(4) in the measurement result analysis device according to (3), the analysis target classification unit may specify a classification set to the other measurement result of which one of items that form the measurement results of the machine tool and the measurement attributes corresponding to the measurement results as a classification of the other comparison target measurement result with respect to the measurement result information classified by the measurement result classification unit.

(5) In the measurement result analysis device according to (3) or (4), the measurement result classification unit may generate a classification table in which the measurement result information and information indicating the classification thereof are correlated with each other on the basis of a classification result of the measurement result information, and the analysis target classification unit may generate an analysis target table in which the classification of the measurement result information and the specified classification of the other comparison target measurement result are correlated with each other.

(6) The measurement result analysis device according to any one of (1) to (5) may further include a measurement execution unit (for example, a program execution unit 11b to be described later) that executes measurement of the machine tool.

(7) A measurement result analysis method according to an aspect of the present invention includes: a measurement result classification step of classifying measurement result information on the basis of the measurement result information in which measurement results of a machine tool and measurement attributes of the measurement results are correlated; a related information acquisition step of acquiring related information including classifications of the measurement result information on the basis of a content of an analysis result for which it is instructed to output with respect to the measurement result information; and an analysis result output step of outputting an analysis result for the measurement result information on the basis of the related information acquired in the related information acquisition step.

(8) A program according to an aspect of the present invention causes a computer to realize: a measurement result classification function of classifying measurement result information on the basis of the measurement result information in which measurement results of a machine tool and measurement attributes of the measurement results are correlated; a related information acquisition function of acquiring related information including classifications of the measurement result information on the basis of a content of an analysis result for which it is instructed to output with respect to the measurement result information; and an analysis result output function of outputting an analysis result for the measurement result information on the basis of the related information acquired by the related information acquisition function.

According to the present invention, it is possible to analyze measurement results of a machine tool more appropriately.

### BRIEF DESCRIPTION OF THE DRAWINGS

FIG. 1 is a block diagram illustrating a configuration of a measurement result analysis device according to an embodiment of the present invention.

FIG. 2 is a schematic diagram illustrating an example of measurement result information.

FIG. 3 is a schematic diagram illustrating an example of a classification table.

FIG. 4 is a schematic diagram illustrating an analysis target table.

FIG. 5 is a schematic diagram illustrating an example of an input screen for displaying an analysis result of measurement results.

FIG. 6 is a schematic diagram illustrating an example of an analysis result related to differences between tools.

FIG. 7 is a schematic diagram illustrating an example of an analysis result related to differences between programs.

FIG. 8 is a schematic diagram illustrating an example of an analysis result related to shapes of works.

FIG. 9 is a flowchart for describing the flow of a measurement result analysis process executed by a measurement result analysis device.

### DETAILED DESCRIPTION OF THE INVENTION

Hereinafter, an embodiment of the present invention will be described with reference to the drawings

### [Configuration]

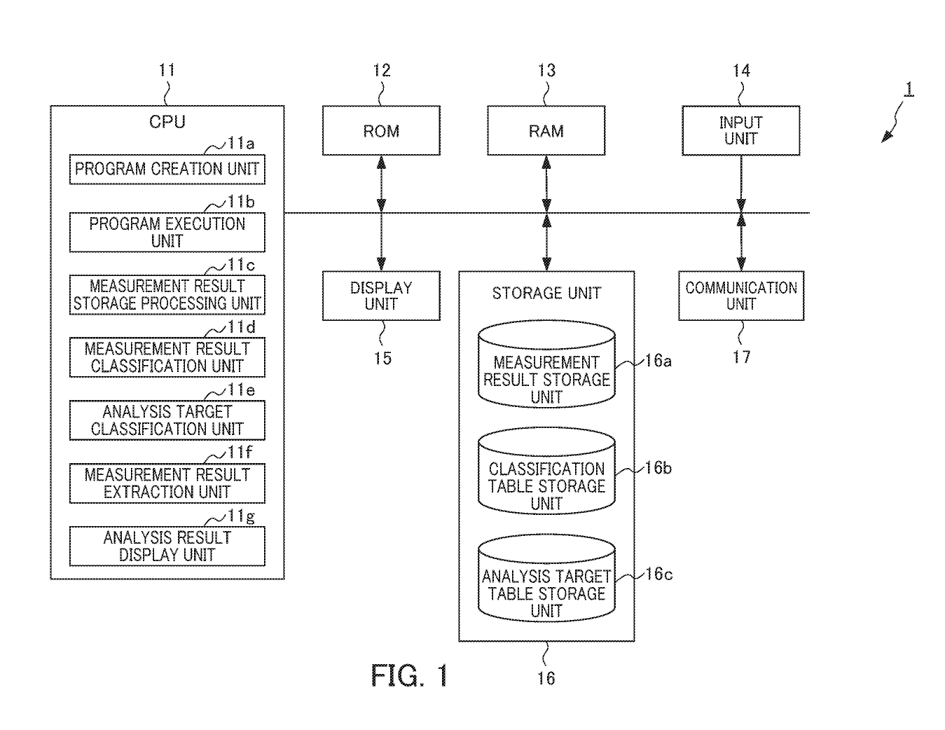

FIG. 1 is a block diagram illustrating a configuration of a measurement result analysis device 1 according to an embodiment of the present invention. As illustrated in FIG. 1, the measurement result analysis device 1 includes a central processing unit (CPU) 11, a ROM 12, a RAM 13, an input unit 14, a display unit 15, a storage unit 16, and a communication unit 17.

In FIG. 1, the CPU 11 controls the entire measurement result analysis device 1 by executing various programs stored in the storage unit 16. For example, the CPU 11 executes a program for a process (hereinafter referred to as a “measurement result analysis process”) of analyzing measurement results of a machine tool. When the program for the measurement result analysis process is executed, a program creation unit 11a, a program execution unit 11b, a measurement result storage processing unit 11c, a measurement result classification unit 11d, an analysis target classification unit 11e, a measurement result extraction unit 11f, and an analysis result display unit 11g are formed in the CPU 11 as a functional configuration.

The program creation unit 11a receives a program creation instruction of a user and creates a program for executing measurement. The program creation unit 11a can select an existing program stored in the storage unit 16 or the like as a program for executing measurement according to an instruction of the user. The program execution unit 11b executes the program created or selected by the program creation unit 11a and executes measurement of the machine tool. The measurement result storage processing unit 11c stores the measurement results of the machine tool executed by the program execution unit 11b and the attributes of measurement in a measurement result storage unit 16a as entries in correlation. Hereinafter, information in which the measurement results of the machine tool and the measurement attributes are correlated with each other will be also referred to appropriately as “measurement result information”.

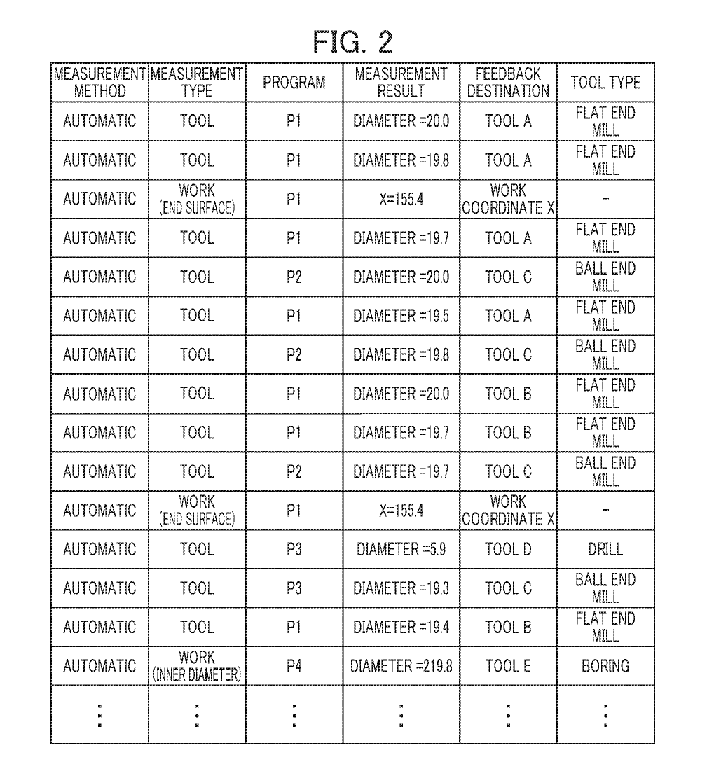

FIG. 2 is a schematic diagram illustrating an example of measurement result information. As illustrated in FIG. 2, the measurement results of the machine tool are stored in correlation with measurement attributes. The measurement attributes include machining conditions of machining of a measurement target and measurement conditions during measurement. The machining conditions include a program for executing measurement and parameters set by the user for measurement. The measurement conditions include a measurement method (whether measurement is automated or manual), a measurement type (whether a measurement target is a tool or a work), and a feedback destination of measurement results (identification information of a tool or a coordinate of a work that correlates measurement results). The feedback destination of measurement results is correlated with a tool type (a flat end mill, a ball end mill, or the like) that correlates measurement results.

The measurement result classification unit 11d classifies the measurement results for each entry of the measurement results stored in the measurement result storage unit 16a. Specifically, the measurement result classification unit 11d classifies the entry of the first row of the measurement results stored in the measurement result storage unit 16a as a first measurement result. Moreover, the measurement result classification unit 11d classifies the entries of the second and subsequent rows of the measurement results stored in the measurement result storage unit 16a, of which the measurement method, the measurement type, the program, and the feedback destination are identical to those of the first measurement result, as the first measurement result. Furthermore, the measurement result classification unit 11d classifies the entries of the second and subsequent rows of the measurement results stored in the measurement result storage unit 16a as new measurement results (second and third measurement results, and the like) whenever entries identical to the already-classified measurement results are detected.

The measurement result classification unit 11d assigns information (a classification number or the like) for identifying classifications of measurement results to the entries of the measurement results stored in the measurement result storage unit 16a to generate table-form data (hereinafter also referred to as a “classification table”) and stores the generated classification table in a classification table storage unit 16b.

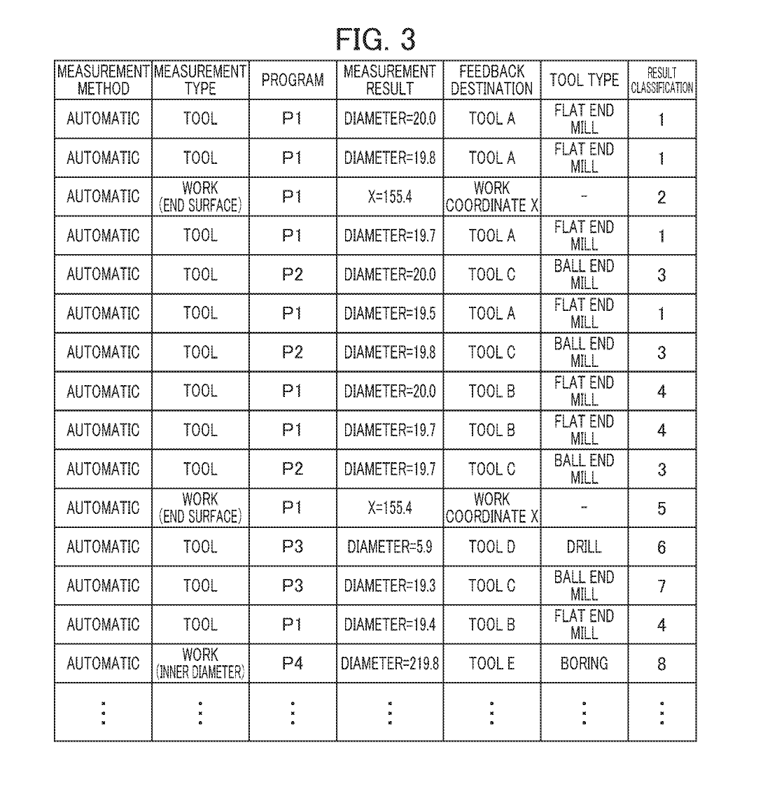

FIG. 3 is a schematic diagram illustrating an example of a classification table. As illustrated in FIG. 3, in the classification table, classifications (result classifications) of measurement results are assigned to respective measurement results and respective measurement attributes. The analysis target classification unit 11e classifies classifications and analysis items of a comparison target measurement result for each classification of the measurement results stored in the classification table storage unit 16b. Specifically, the analysis target classification unit 11e specifies other classifications of measurement result of which only one item (a measurement method, a measurement type, a program, and a feedback destination) is different from that of the classifications of the measurement results in the order of classifications of the measurement results stored in the classification table storage unit 16b. The only one different item is analysis target information between different classifications of measurement results. The analysis target classification unit 11e assigns information (a classification number or the like) for identifying the specified other classification of measurement results to the classifications of the measurement results stored in the classification table storage unit 16b to generate table-form data (hereinafter also referred to as an “analysis target table”) and stores the generated analysis target table in an analysis target table storage unit 16c. In the present embodiment, the analysis target classification unit 11e assigns one item which is different between different classifications of measurement results to the classifications of measurement results as an analysis item to generate an analysis target table. When there is no other classification of measurement results of which only one item (a measurement method, a measurement type, a program, and a feedback destination) is different from that of classifications of measurement results, the analysis target classification unit 11e stores information indicating that there is no other classification of measurement results corresponding to the classification of measurement results in the analysis target table.

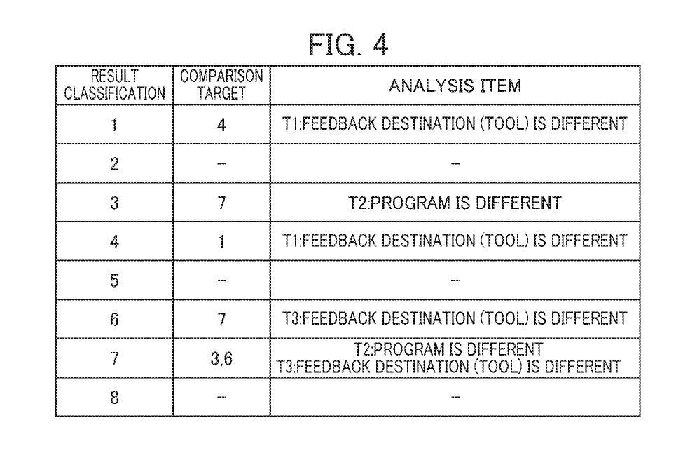

FIG. 4 is a schematic diagram illustrating an example of an analysis target table. As illustrated in FIG. 4, in the analysis target table, another measurement result of which only one item is different from that of classifications of measurement results is specified for a classification of measurement results. For example, classification “4” of measurement results of which only a feedback destination tool is different from that of classification “1” of measurement results is specified for classification “1” of measurement results. Moreover, classification “3” having a different program and classification “6” having a different feedback destination tool are specified for classification “7” of measurement results.

A measurement result extraction unit 11f reads information related to a measurement result for which it is instructed to display an analysis result on an analysis result display unit 11g from the measurement result storage unit 16a, a classification table storage unit 16b, and an analysis target table storage unit 16c and outputs the information to the analysis result display unit 11g. The analysis result display unit 11g acquires information related to a measurement result of which the analysis result is to be displayed via the measurement result extraction unit 11f according to a user's instruction. The analysis result display unit 11g executes analysis (analysis related to difference between tools, analysis related to difference between programs, analysis related to shapes of works, and the like) of measurement results corresponding to the user's instruction and displays an analysis result on the display unit 15.

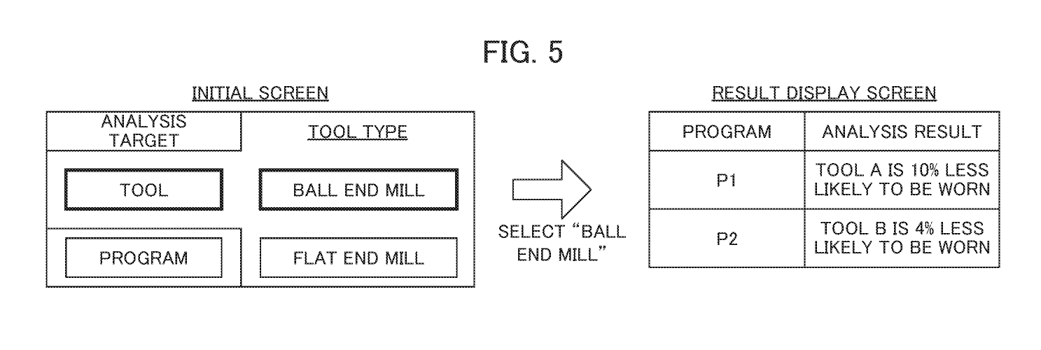

FIG. 5 is a schematic diagram illustrating an example of an input screen for displaying an analysis result of measurement results. In the input screen example illustrated in FIG. 5, a user can select any one item of “tool” and “program” as an analysis target on an initial screen. When the user selects any one item of “tool” and “program”, items (subordinate items) subordinate to the selected item are displayed as selectable items. In the input screen example illustrated in FIG. 5, “tool” is selected, and as a result, “ball end mill” and “flat end mill” are displayed selectable as “tool type” which is a subordinate item subordinate to “tool”. When the user selects any one subordinate item, analysis results for the subordinate item as an analysis target are displayed as a list on a screen subsequent to the initial screen (hereinafter also referred to as a “result display screen”). In the example illustrated in FIG. 5, analysis results for “flat end mill” selected by the user are displayed as a list, on the result display screen.

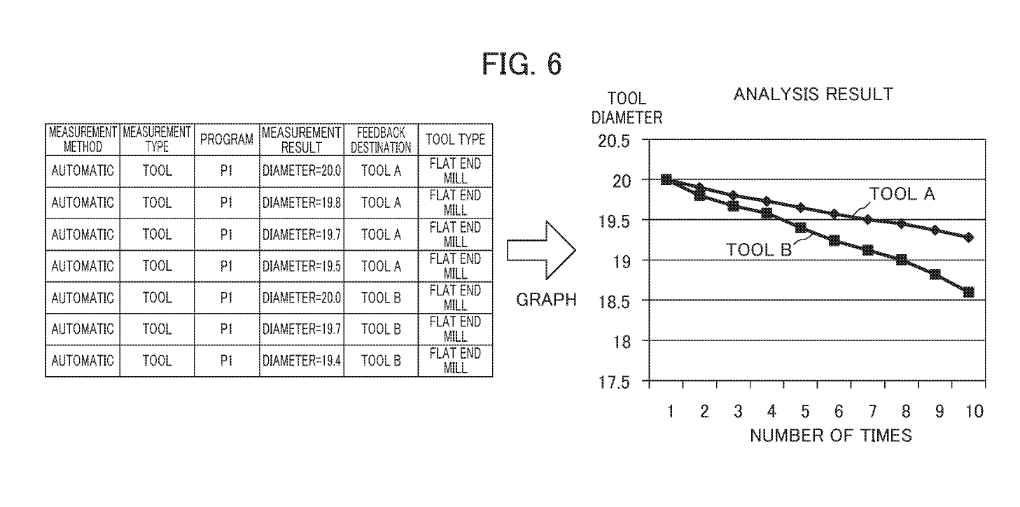

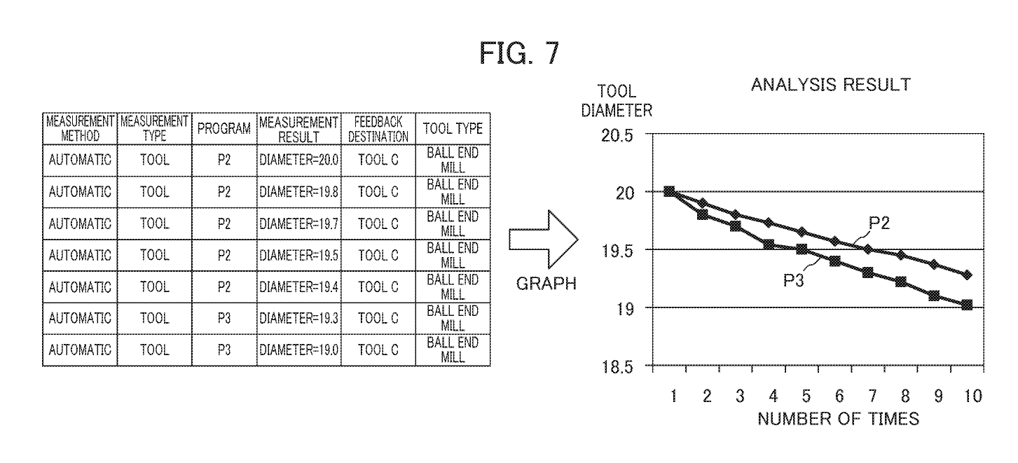

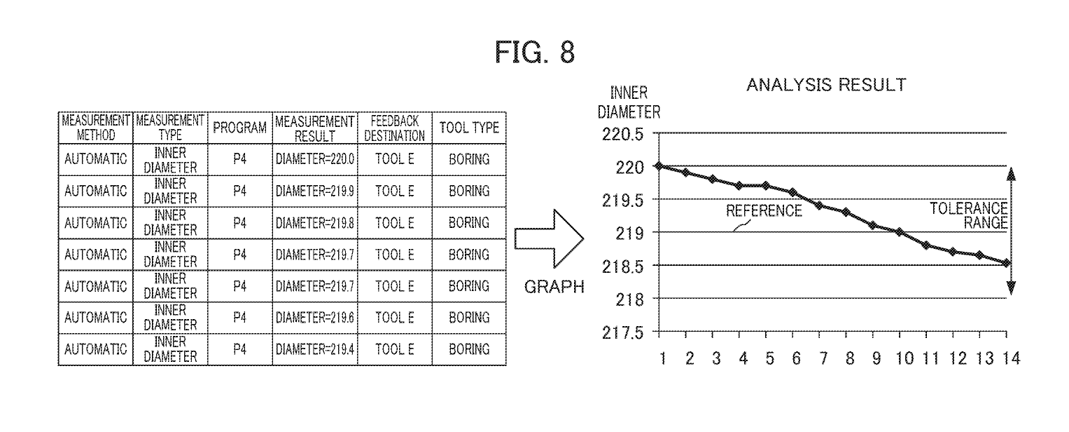

FIGS. 6 to 8 are schematic diagrams illustrating an example of analysis results. FIG. 6 is a diagram illustrating an example of analysis results related to difference between tools. FIG. 7 is a diagram illustrating an example of analysis results related to differences between programs, and FIG. 8 is a diagram illustrating an example of analysis results related to shapes of works. As illustrated an FIG. 6, when classifications of measurement results in which feedback destination tools are different are analyzed, a relation between a number of machining times and a tool diameter is displayed as a graph for each tool type with respect to a machining result (in this example, a tool diameter) included in the measurement results. In the example illustrated in FIG. 6, it is understood that tool A (a ball end mill) is not easily worn than tool B (a flat end mill).

As illustrated in FIG. 7, when classifications of measurement results in which programs (machining conditions) are different are analyzed, a relation between a number of machining times and a tool diameter is displayed as a graph for each program with respect to a machining result (in this example, a tool diameter) included in the measurement results. In the example illustrated in FIG. 7, it is understood that the tool is not easily worn under the machining condition of program P2 than the machining condition of program P3.

As illustrated in FIG. 8, when work shapes (in this example, the inner diameters of bored holes) are analyzed, a relation between a number of machining times and a work shape (the inner diameter of a bored hole) is displayed as a graph with respect to the machining result included in respective measurement results of the same classification. In the example illustrated in 8, it is understood that the machining results for the first to fourteenth machining fall within a tolerance range allowable for a reference inner diameter.

In FIG. 1, various system programs for controlling the measurement result, analysis device 1 are written in advance in the ROM 12. The RAM 13 is configured as a semiconductor memory such as a dynamic random access memory (DRAM) and stores data generated when the CPU 11 executes various processes. The input unit 14 is configured as an input device such as a keyboard, a mouse, or a touch sensor, and receives various pieces of information that a user inputs to the measurement result analysis device 1.

The display unit 15 is configured as a display device such as a liquid crystal display (LCD) and displays various processing results of the measurement result analysis device 1. The storage unit 16 is configured as a nonvolatile storage device such as a hard disk or a flash memory and stores programs and the like for a measurement result analysis process. The measurement result storage unit 16a in which entries that correlate measurement results of a machine tool executed by the program execution unit 11b with measurement attributes are stored, the classification table storage unit 16b in which the classification table as stored, and the analysis target table storage unit 16c in which the analysis target table is stored are formed in the storage unit 16.

In FIG. 1, the communication unit 17 includes a communication interface that performs signal processing on the basis of a predetermined communication standard such as a cable or wireless LAN or a USB and controls communication performed between the measurement result analysis device 1 and other devices.

### [Operation]

Next, an operation of the measurement result analysis device 1 will be described.

### [Measurement Result Analysis Process]

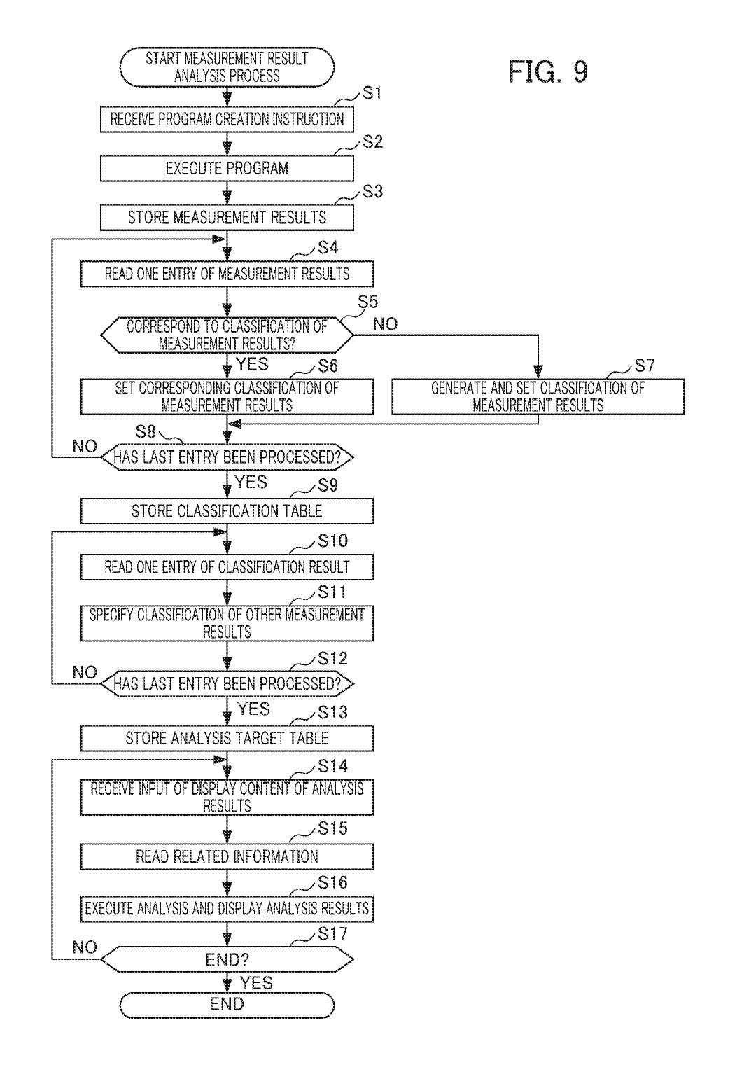

FIG. 9 a flowchart for describing the flow of a measurement result analysis process executed by the measurement result analysis device 1. The measurement result analysis process starts when an instruction to activate the measurement result analysis process is input via the input unit 14.

In step S1, the program creation unit 11a receives a program creation instruction of a user and creates a program for executing measurement. In this case, the program creation unit 11a may select an existing program stored in the storage unit 16 or the like as a program for executing measurement according to the user's instruction.

In step S2, the program execution unit 11b executes a program created or selected by the program creation unit 11e. In this way, measurement of a machine tool is executed

In step S3, the measurement result storage processing unit 11c stores the measurement results of a machine tool executed by the program execution unit 11b and the measurement attributes in the measurement result storage unit 16a in correlation as entries (measurement result information).

In step S4, the measurement result classification unit 11d reads one entry of the measurement results stored in the measurement result storage unit 16a.

In step S5, the measurement result classification unit 11d determines whether the read entry of measurement results corresponds to an already-present classification of measurement results. When the read entry of measurement results corresponds to an already-present classification of measurement results, a determination result of YES is obtained in step S5, and the flow proceeds to step S6. On the other hand, when the read entry of measurement results does not correspond to an already-present classification of measurement results, a determination result of NO is obtained in step S5, and the flow proceeds to step S7.

In step S6, the measurement result classification unit 11d sets the corresponding classification of measurement results to the read entry of measurement results. After step S6 is performed, the flow proceeds to step S8.

In step S7, the measurement result classification unit 11d generates a new classification of measurement results corresponding to the read entry of measurement results and sets the new classification to the entry of measurement results.

In step S8, the measurement result classification unit 11d determines whether the last entry of measurement results stored in the measurement result storage unit 16a has been processed. When the last entry of measurement results stored in the measurement result storage unit 16a has been processed, a determination result of YES is obtained in step S8 and the flow proceeds to step S9. On the other hand, when the last entry of measurement results stored in the measurement result storage unit 16a has not been processed, a determination result of NO is obtained in step S8 and the flow proceeds to step S4.

In step S9, the measurement result classification unit 11d stores a classification table in which information (a classification number or the like) for identifying classifications of measurement results is assigned to the entries of measurement results in the classification table storage unit 16b.

In step S10, the analysis target classification unit 11e reads one entry of classifications of measurement results stored in the classification table storage unit 16b.

In step S11, the analysis target classification unit 11e specifies other classifications of measurement result of which only one item (a measurement method, a measurement type, a program, and a feedback destination) is different from that of the read entry of classifications of measurement results.

In step S12, the analysis target classification unit 11e determines whether the last entry of classifications of measurement results stored in the classification table storage unit 16b has been processed. When the last entry of classifications of measurement results stored in the classification table storage unit 16b has been processed, a determination result of YES is obtained in step S12 and the flow proceeds to step S13. On the other hand, when the last entry of classifications of measurement results stored in the classification table storage unit 16b has not been processed, a determination result of NO is obtained in step S12 and the flow proceeds to step S10.

In step S13, the analysis target classification unit 11e stores an analysis target table in which information (a classification number or the like) for identifying the specified other classifications of measurement results to classifications of measurement results stored in the classification table storage unit 16b in the analysis target table storage unit 16c.

In step S14, the analysis result display unit 11g receives an input (an instruction on measurement results for which analysis results are to be displayed) of a display content of analysis results from the user.

In step S15, the measurement result extraction unit 11f reads information related to the input display content of analysis results from the measurement result storage unit 16a, the classification table storage unit 16b, and the analysis target table storage unit 16c.

In step S16, the analysis result display unit 11g executes analysis (analysis related to difference between tools, analysis related to difference between programs, analysis related to shapes of works, and the like) of measurement results corresponding to the user's instruction and displays an analysis result on the display unit 15.

In step S17, the analysis result display unit 11g determines whether an instruction to end the measurement result analysis process has been input. When an instruction to end the measurement result analysis process has not been input, a determination result of NO is obtained in step S17 and the flow proceeds to step S14. On the other hand, when an instruction to end the measurement result analysis process has been input, a determination result of YES is obtained in step S17 and the measurement result analysis process ends.

As described above, the measurement result analysis device 1 according to the present embodiment stores measurement results of a machine tool in correlation with measurement attributes. The measurement result analysis device 1 classifies the stored measurement results on the basis of a measurement method, a measurement type, a program, and a feedback destination. The measurement result analysis device 1 classifies classifications and analysis items of comparison target measurement results for each classification of measurement results. The measurement result analysis device 1 reads information related to a measurement result for which it is instructed to display an analysis result from the measurement result storage unit 16a, the classification table storage unit 16b, and the analysis target table storage unit 16c and executes analysis (analysis related to difference between tools, analysis related to difference between programs, analysis related to shapes of works, and the like) of measurement results corresponding to the user's instruction. The measurement result analysis device 1 displays the analysis result on the display unit 15. Due to this, even when various measurements are executed in a time-series order in a machine tool, it is possible to easily extract measurement results aiming at analysis of a specific item and to acquire analysis results. Therefore, it is possible to analyze measurement results of a machine tool more appropriately.

The measurement result analysis device 1 sets an existing classification of measurement results to an entry of measurement results identical to already-classified measurement results and generates and sets a new classification of measurement results whenever an entry that is not identical to the already-classified measurement results is detected. In this way, it is possible to set classifications of measurement results appropriately to various measurement results.

The measurement result analysis device 1 specifies other classifications of measurement result of which only one item (a measurement method, a measurement type, a program, and a feedback destination) is different from that of the classifications of the measurement results in the order of classifications of the measurement results. The measurement result analysis device 1 assigns information (a classification number or the like) for identifying the specified other classification of measurement results to the classifications of measurement results. In this way, it is possible to appropriately specify other measurement results and comparison target items with which it is possible to compare measurement results to perform analysis.

The measurement result analysis device 1 assigns information (a classification number or the like) for identifying classifications of measurement results to the entries of measurement results to create a classification table. In this way, it is possible to easily analyze various acquired measurement results.

The measurement result analysis device 1 executes a program for performing measurement of a machine tool. In this way, a device that performs measurement of a machine tool can analyze measurement results more appropriately.

The present invention is not limited to the above-described embodiment and modification but various changes, modifications, and the like can be made. For example, in the above-described embodiment, the analysis result display unit 11g displays the analysis results acquired by the measurement result analysis device 1 on a display screen. However, a method of outputting the analysis results is not limited to displaying on a display screen. For example, analysis result data may be transmitted to another device, the analysis results may be printed on a printing medium, or analysis result data may be stored in a storage medium.

In the above-described embodiment, the measurement result analysis device 1 executes a program, acquires measurement results, classifies measurement results, specifies classifications of other comparison target measurement results, analyzes measurement results, and displays anal sis results. However, there is no limitation thereto. That is, the measurement result analysis device 1 may perform some of these processes and the other processes may be executed by a device other than the measurement result analysis device 1. For example, the other device may execute a program and acquire measurement results, and the measurement result analysis device 1 may classify measurement results, specify classifications of other comparison target measurement results, analyze measurement results, and display analysis results. It is sufficient that the classifications of the other comparison target measurement results are specified when a plurality of classifications of measurement results are compared. That is, for example, when a work shape (the inner diameter of a bored hole) is analyzed, a classification of the other comparison target measurement results may not be specified for analysis which does riot require comparison with other classifications of measurement results.

In the above-described embodiment, when analysis results are displayed, qualitative characteristics (values indicating the unlikeliness of wearing in a plurality of tools) may be output in addition to qualitative characteristics (comparison results of unlikeliness of wearing in a plurality of tools) of analysis targets.

All or some of the functions of the measurement result analysis device 1 of the above-described embodiment can be realized by hardware, software, or a combination thereof. Here, being realized by software means being realized when a computer reads and executes a program. When the functions are realized by hardware, sonic or all of the functions of the measurement result analysis device 1 may be realized, for example, by an integrated circuit (IC) such as an application specific integrated circuit (ASIC), a gate array, a field programmable gate array (FPGA), and a complex programmable logic device (CPLD).

When all or some of the functions of the measurement result analysis device 1 are realized by software, the functions may be realized when a computer including a storage unit such as a hard disk or a ROM storing programs that describe all or some of the operations of the measurement result analysis device 1, a DRAM that stores data necessary for operations, a CPU, and a bus that connects respective units stores information necessary for operations in a DRAM, and the CPU executes the programs.

The programs can be stored using various types of computer readable media and be provided to a computer. The computer readable media include various types of tangible storage media. Examples of the computer readable media include a magnetic recording medium (for example, a flexible disk, a magnetic tape, and a hard disk drive), a magneto-optical recording medium (for example, a magneto--optical disk), a CD-ROM (Read Only Memory), a CD-R, a CD-R/W, a CVD-ROM (Digital Versatile Disk), a DVD-R, a DVD-R/W, a semiconductor memory (for example, a mask ROM, a PROM (Programmable ROM), an EPROM (Erasable PROM), a flash memory, and a RAM (Random Access Memory)). These programs may be distributed by being downloaded to a computer of a user via a network.

While the embodiment of the present invention has been described in detail, the embodiment merely illustrates a specific example of implementation of the present invention. The technical scope of the present invention is not limited to the embodiment. Various changes can be made without departing from the spirit of the present invention, and these changes also fall within the technical scope of the present invention.

### EXPLANATION OF REFERENCE NUMERALS

1: Measurement result analysis device
11: CPU
11a: Program creation unit
11b: Program execution unit (Measurement execution unit)
11c: Measurement result storage processing unit.
11d: Measurement result classification unit
11e: Analysis target classification unit
Measurement result extraction unit (Related information acquisition unit)
11g: Analysis result display unit (Analysis result output unit)
12: ROM
13: RAM
14: Input unit
15: Display unit
16: Storage unit
16a: Measurement result storage unit
16b: Classification table storage unit
16c: Analysis target table storage unit
17: Communication unit

What is claimed is:

1. A measurement result analysis device comprising:
a measurement result classification unit that classifies measurement result information on the basis of the measurement result information in which measurement results of a machine tool and measurement attributes of the measurement results are correlated;
a related information acquisition unit that acquires related information including classifications of the measurement result information on the basis of a content of an analysis result for which it is instructed to output with respect to the measurement result information; and
an analysis result output unit that outputs an analysis result for the measurement result information on the basis of the related information acquired by the related information acquisition unit.

2. The measurement result analysis device according to claim 1, wherein
the measurement result classification unit determines whether the measurement result information corresponds to an already-existing classification of the measurement result information, sets the corresponding classification of the measurement result information when the measurement result information corresponds to the already-existing classification of the measurement result information, and generates a new classification of the measurement result information and sets the generated new classification of the measurement result information when the measurement result information does not corresponds to the already-existing classification of the measurement result information.

3. The measurement result, analysis device according to claim 1, further comprising:
an analysis target classification unit that specifies a classification of the other comparison target measurement result with respect to the measurement result information classified by the measurement result classification unit, wherein
the related information acquisition unit acquires related information including classifications of the measurement result information and a classification of the other comparison target measurement results on the basis of a content of an analysis result for which it is instructed to output with respect to the measurement result information.

4. The measurement result analysis device according to claim 3, wherein
the analysis target classification unit specifies a classification set to the other measurement result of which one of items that form the measurement results of the machine tool and the measurement attributes corresponding to the measurement results as a classification of the other comparison target measurement result with respect to the measurement result information classified by the measurement result classification unit.

5. The measurement result analysis device according to claim 3, wherein
the measurement result classification unit generates a classification table in which the measurement result information and information indicating the classification thereof are correlated with each other on the basis of a classification result of the measurement result information, and
the analysis target classification unit generates an analysis target table in which the classification of the measurement result information and the specified classification of the other comparison target measurement result are correlated with each other.

6. The measurement result analysis device according to claim 1, further comprising:
a measurement execution unit that executes measurement of the machine tool.

7. A measurement result analysis method comprising:
a measurement result classification step of classifying measurement result information on the basis of the measurement result information in which measurement results of a machine tool and measurement attributes of the measurement results are correlated;
a related information acquisition step of acquiring related information including classifications of the measurement result information on the basis of a content of as analysis result for which it is instructed to output with respect to the measurement result information; and
an analysis result output step of outputting an analysis result for the measurement result information on the basis of the related information acquired in the related information acquisition step.

8. A non-transitory computer readable storage medium storing a program for causing a computer to realize:
a measurement result classification function of classifying measurement result information on the basis of the measurement result information in which measurement results of a machine tool and measurement attributes of the measurement results are correlated;
a related information acquisition function of acquiring related information including classifications of the measurement result information on the basis of a content of an analysis result for which it is instructed to output with respect to the measurement result information.; and
an analysis result output function of outputting an analysis result for the measurement result information on the basis of the related information acquired by the related information acquisition function.
